(19) United States
(12) Patent Application Publication
(10) Pub. No.: US 2008/0288442 A1
(43) Pub. Date: Nov. 20, 2008

(54) Ontology Based Text Indexing

(75) Inventors: Lee Feigenbaum, Brookline, MA (US); Matthew N. Roy, Norwood, MA (US); Benjamin H. Szekely, Boston, MA (US); Wing C. Yung, Somerville, MA (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 11/747,930

(22) Filed: May 14, 2007

(51) Int. Cl. G06F 17/30

(52) U.S. Cl. 707/2; 707/E17.017

(57) ABSTRACT

A method and system are disclosed for indexing a set of statements, such as RDF statements, that are described in accordance with a specified ontology. The method comprises the steps of defining a set of indexing rules, and using these indexing rules to examine the statements to identify selected ones of the statements and to generate one or more indices from said selected ones of the statements. In a preferred embodiment, the rules match certain predicates of RDF statements to certain indices. Also, preferably, an RDF storage system may be configured with said set of indexing rules. When RDF statements are added to the RDF storage system, each statement is examined by the indexing subsystem. If the predicate of a statement matches one of the predicates of said set of indexing rules, that rule is applied to the statement.

### BACKGROUND OF THE INVENTION

1. Field of the Invention

The present invention relates to ontology based text indexing, and more specifically, the invention relates to indexing semantic knowledge represented by the Resource Description Framework.

2. Background Art

An enormous amount of information is available through public and private databases. Often, though, it may be very difficult for an individual to find, in this huge information base, the specific information that individual is looking for.

For instance, the Internet, which was created to keep a small group of scientists informed, has now become so vast that it is no longer easy to find information. Even the simplest attempt to find information may result in data overload. The Internet is a highly unorganized and unstructured repository of data, whose growth rate is ever increasing. As the data grows, it becomes more and more difficult to find relevant information.

Early pioneers in information retrieval from the Internet developed novel approaches, which can be categorized in two main areas: automated keyword indexing and manual document categorization. The large majority of current search engines use both of these approaches. For example, the earliest generation of search engines, including Lycos, AltaVista, and WebCrawler, as well as more recent ones, such as Northern Light or FAST, are all based on keyword indexing and searching. Another very popular search engine, Yahoo!, is actually a categorized repository of documents that have been manually categorized by human laborers.

Searching for information using the keyword approach requires the user to input a set of words, which can range from a single word to a natural language sentence. Normally, the input is parsed into an unstructured set of keywords. The set of keywords is then matched against an inverted index that links keywords with the documents in which they appear. Documents with the most keywords that match the input query are retrieved. Some ranking process generally follows this retrieval and orders the returned documents by how many times the query words appear within them. The problem with this approach is that no attempt is made to identify the meaning of the query and to compare that meaning with the meaning of the documents. Therefore, there is a clear need to develop new systems that can take this into consideration.

A second approach is manual document organization. A typical document categorization search engine, Yahoo!, does not contain an inverted index, but rather a classification of documents manually categorized in a hierarchical list. When a user queries Yahoo!, a keyword-based search is run against the words used to classify documents, rather than the documents themselves. Every time the search engine capability is used, it displays the location of the documents within the hierarchy. While this approach is useful to users, so far as it means that other humans have employed common sense to filter out documents that clearly do not match, it is limited by two factors. The first factor is that it does not scale to the number of documents now available on the web, as the directory only can grow as quickly as human editors can read and classify pages. The second factor is that it does not understand the meaning of the query, and a document classified under a particular word will not be retrieved by a query that uses a synonymous word, even though the intent is the same.

As a result, there is a pressing need to develop search engines that bridge the gap between the meaning of an input query and pre-indexed documents. Existing approaches will not solve this problem, because it is impossible to determine the meaning of input queries from terms alone. A successful approach must also make use of the structure of the query.

To help organize data in a more meaningful way, the Resource Description Framework, or RDF, was developed. RDF is a language that was originally developed for representing information (metadata) about resources in the World Wide Web. It may, however, be used for representing information about absolutely anything. When information has been specified using die generic RDF format, it may be automatically consumed by a diverse set of applications.

Facts in RDF are represented by RDF triples. Each RDF triple represents a fact and is made up of three parts, a subject, a predicate, (sometimes termed a property), and an object. For example, the fact represented by the English sentence “John is 24 years old” is represented in RDF by the subject, predicate, object triple <‘John’, ‘age’, ‘24’>, with ‘John’ being the subject, ‘age’ being the predicate, and ‘24’ being the object. The values of objects may be literal values such as numbers or character strings. The interpretations given to the members of the triple are determined by the application that is using it.

While the semantic web is effective for storing data in a flexible format, its simplicity generally leads to huge databases of triples that could be from multiple applications. Some of these triples contain text data that users will want to search. One solution is to index all textual data that is stored, but this is a waste of resources for applications that do not care about text search. Adding items to a text index is a nontrivial operation.

There are different types of text indices for different types of searches. The most basic type of index is on a word level (so that only whole words can be submitted as search queries), but another type of index can be used to search text on a sub-word level (so that parts of words can be submitted as search queries). The latter is more resource intensive, and is not meant to be applied to long spans of text. Currently, there is no way to designate that a particular statement should be indexed in a particular way (or not at all).

### SUMMARY OF THE INVENTION

An object of the present invention is to provide an ontology-based text indexing method and system.

Another object of the invention is to designate that a particular RDF statement should be indexed in a particular way (or not at all).

A further object of this invention is to mark up an ontology with metadata to determine which statements containing text data should be indexed by the storage system, how they should be indexed, and where they should be indexed.

These and other objectives are attained with a method and system for indexing a set of statements, such as RDF statements, that are described in accordance with a specified ontology. The method comprises the steps of defining a set of indexing rules, and using said set of indexing rules to examine said set of statements to identify selected ones of the set of statements and to generate one or more indices from said selected ones of the statements. In a preferred embodiment, the rules match certain predicates of RDF statements to certain indices.

In a preferred embodiment of the invention, an RDF storage system is configured with said set of indexing rules. When RDF statements are added to the RDF storage system, each statement is examined by the indexing subsystem. If the predicate of a statement matches one of the predicates of said set of indexing rules, that rule is applied to the statement. The application of a rule to a statement involves indexing the text of the object to generate an index object to be inserted into the specified index. The index object is also associated with the subject and predicate of the statement so that when a text query is matched, the entire statement can be retrieved from the index.

Preferably, an ontology is marked with metadata to determine which statements containing text data should be indexed by the storage system, how they should be indexed, and where they should be indexed. In this way, for example, each application running on the RDF database can have its own index.

The preferred embodiment of the invention, described in detail below, provides a number of important advantages. For instance, the invention may be used to save both storage space and processing time for the database system. Also, the invention speeds up search queries because only relevant text goes into a particular index.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 shows a graph of a group of four RDF statements.

FIG. 2 illustrates a system for indexing an RDF database.

FIG. 3 shows an ontology for a system that describes a person.

FIG. 4 is a block diagram of an exemplary computing environment in which aspects of the invention may be implemented.

### DETAILED DESCRIPTION OF THE PREFERRED EMBODIMENTS

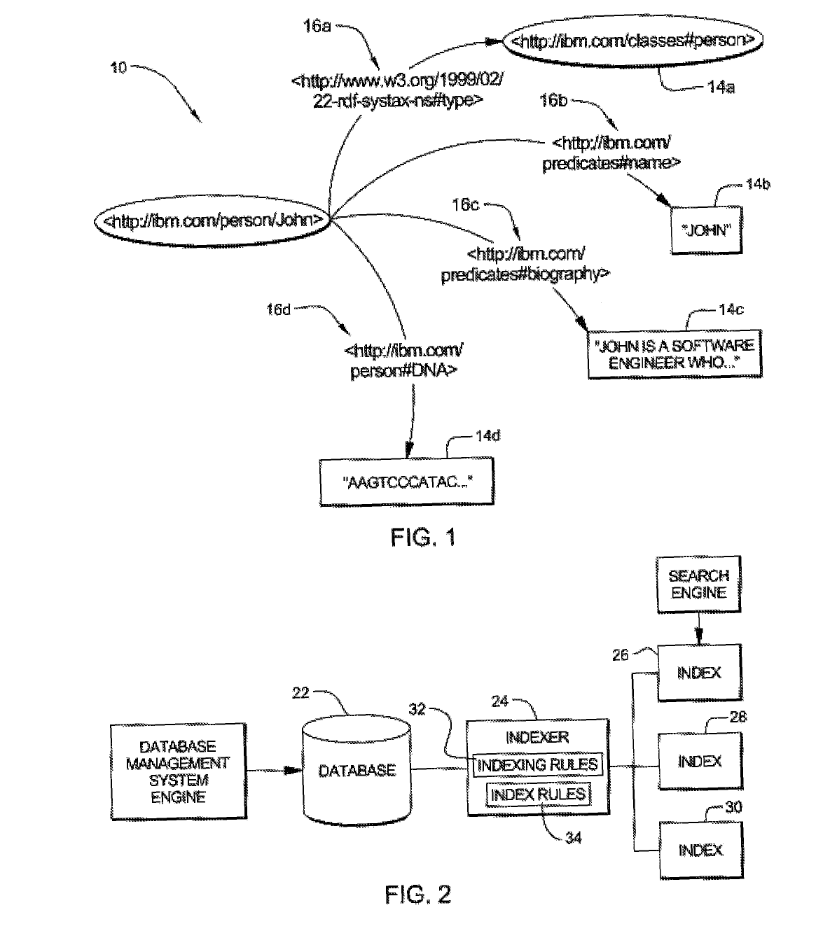

The present invention provides a method and system for indexing semantic knowledge, preferably represented by the Resource Description Framework (RDF). Data in RDF are represented by RDF statements, each of which is comprised of a subject, a predicate (sometimes termed property), and an object. RDF statements may be represented as a graph, and, for example, FIG. 1 shows a graph 10 of a group of RDF statements. These four statements each have the same subject 12. Each statement also has a predicate (16a, 16b, 16c and 16d) and an object (14a, 14b, 14c and 14d). The subject is <John>, the four predicates are <type>, <name>, <biography>, and <DNA>, and the four objects are the values for these four predicates for the subject <John>. In particular, the object 14a is John's type, which is <person>, object 14b is John's name, object 14c is a biography of John, and object 14d is John's DNA. Also, as shown in FIG. 1, the subject 12, each of the predicates 16a, 16b, 16c and 16d, and a first object 16a have globally unique uniform resource identifiers (URIs).

RDF is used to store data in the Semantic Web, which introduces a wealth of loosely structured, machine-readable data. This data can be queried with a query language such as SPARQL. However, writing SPARQL requires the user to understand the loose structure of the particular body of RDF data. As such, traditional textual searches are still required for users to find important entry points into bodies of RDF data.

Text indexing is the practice of building auxiliary data structures to render textual searches fast. However, text indexing can be expensive in processing time, disk space, and memory space. In addition, in completely unstructured environments, such as large bodies of text, all text must be indexed in order to answer queries. In accordance with the preferred embodiment of the present invention, choosing certain RDF predicates to index can optimize indexing of the text within RDF.

FIG. 2 illustrates a system 20 for indexing RDF data. More specifically, FIG. 2 shows a database 22 of RDF triples, an indexer 24 for indexing the database 22 in a manner described in more detail below, and a plurality of indexes 26, 28 and 30 for receiving the indexed data. A first set of rules, represented at 32, are used to determine how the RDF data are indexed; and a second set of rules, represented at 34, are used to determine which of the indexes into which to place the indexed data.

The preferred embodiment of the invention includes a system of rules (which can be encoded in RDF) to supplement the ontology. These rules are registered with the RDF database so that any time a statement is added, changed or removed, the predicate is examined to determine which text indices (if any) should be updated. Some example rules are: index every predicate in an ontology; index every predicate that has a specific class as its subject; and index a specific predicate.

As mentioned above, in the preferred embodiment of the invention, indexer 24 forms a plurality of indexes 26, 28, 30; and rules 34 are used to determine which of the indexes into which to place the indexed data. In addition, in this preferred embodiment of the invention, when each predicate is copied into one of the indexes, the subject and object of the RDF triple to which that predicate belongs are also copied into that same index.

As an example of the preferred implementation of this invention, suppose an ontology describing books is provided. Rules can be set up to have the RDF database create a normal text index on the book titles, book descriptions, and author names. A type-ahead index on the book titles and author names can also be set up (because they are short and are most effective for this type of search).

The advantage of using this solution is that resources are not wasted on text indexing where is it not needed.

For example, if the RDF database is used to store information on people, the text indexer can be informed to index the name and short biography, but not the DNA string. In addition, different predicates might need different types of indexes.

For example, applications might require very fast, instantaneous searches, such as those used in type-ahead text fields AJAX Web Applications. Therefore, all the text strings of the “name” predicate could be indexed in fast, in memory suffix-based text indexes, such as the “suffix array” or “suffix tree.” This type of index allows fast searches for parts of words so it is appropriate for things like names. Its memory requirements make it impractical for longer strings, like the short biographies, which might be several hundred characters long. These strings are too long to permit suffix-based indexing so, for these strings, it may be preferred to use a traditional disk-based text index, that admits fast, but not immediate search results. Finally, there might be some properties (like DNA string) that a user might not want to index at all, perhaps for performance reasons.

In one embodiment of this invention, the data is stored in an RDF database such as Boca, an RDF store based on a relational database (formally known as CART). In the same or in a similar embodiment, the indexing directives are specified in an OWL or RDFS ontology. OWL and RDFS ontologies are special RDF documents that describe structure within RDF data. In particular, they specify information about the predicates that make-up the graph of information in the RDF data.

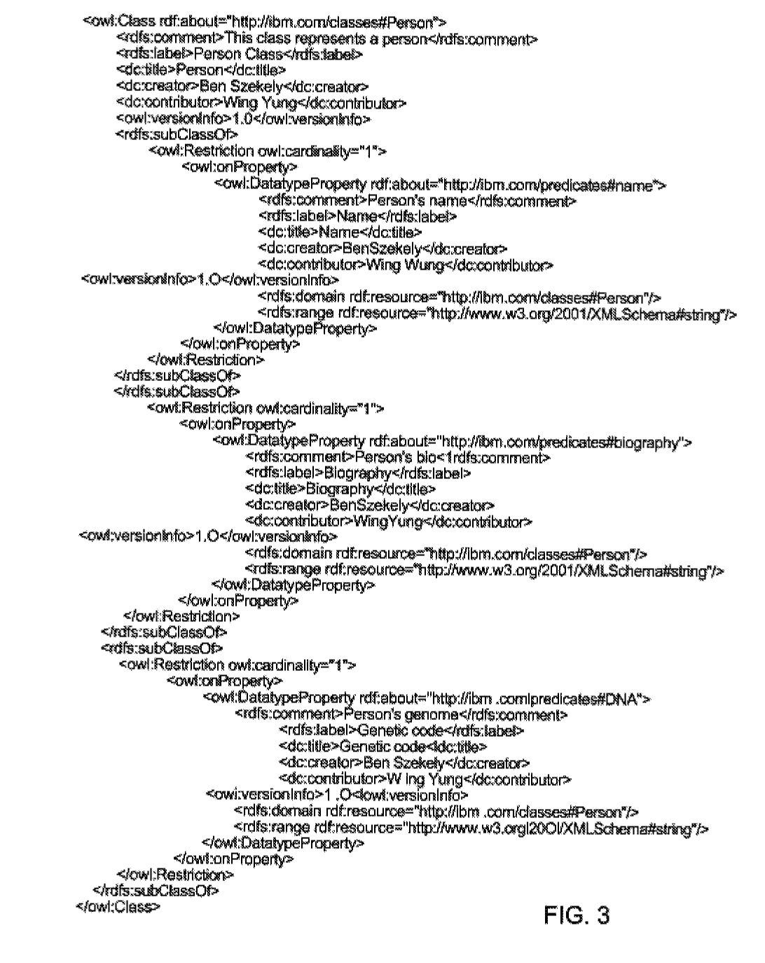

FIG. 3 shows an ontology for a fictional system that describes a person. The three properties (predicates) that are defined are:
name (http://ibm.com/predicates#name);
biography (http://ibm.com/predicates#biography)—a paragraph or two describing the person; and
DNA (http://ibm.come/predicates#DNA)—the person's genome.

It may be desirable to be able to designate certain types of indices for certain fields. Supplemental information can be included in the same OWL file or a separate file.

The “name” predicate may be indexed with a type-ahead index so that users can search for names by typing in substrings of the names. This type of search lends itself well for short, highly searched fields. This type of index allows the user to search for substrings of the text. For instance, to find ‘Wing’ the user can type ‘Wi’ or ‘Win’ or even ‘ing’.

<owl:DatatypeProperty rdf:about=”http ://ibm.com/predicates#na me”>
<http://ib m.com/predicates#in dexType
>TextIndexSuffix</http ://www.ib m.com/predicates#inde xType>
</owl:DatatypeProperty>

The biography should be indexed with a normal text index so that it can be searched. With this text index, the user searches for entire words (instead of substrings). Searching for ‘wi’ or ‘win’ will not return results that contain the word ‘wing’ (unless these results also contain the words ‘wi’ or ‘win’). This type of index does not require as much storage or processing power.

<owl:DatatypeProperty rdf:about=“http ://ib m.com/predicates#
bigorap hy”>
<http://ibm.co m/pred icates#indexType
>TextIndexNormal</http://www.ibm.co m/predicat es#indexType>
</owl:DatatypeProperty>

We do not want to index the last property even though it has a string object. The string would be billions of letters long and in our example; we do not want to index it in any manner in our data store.

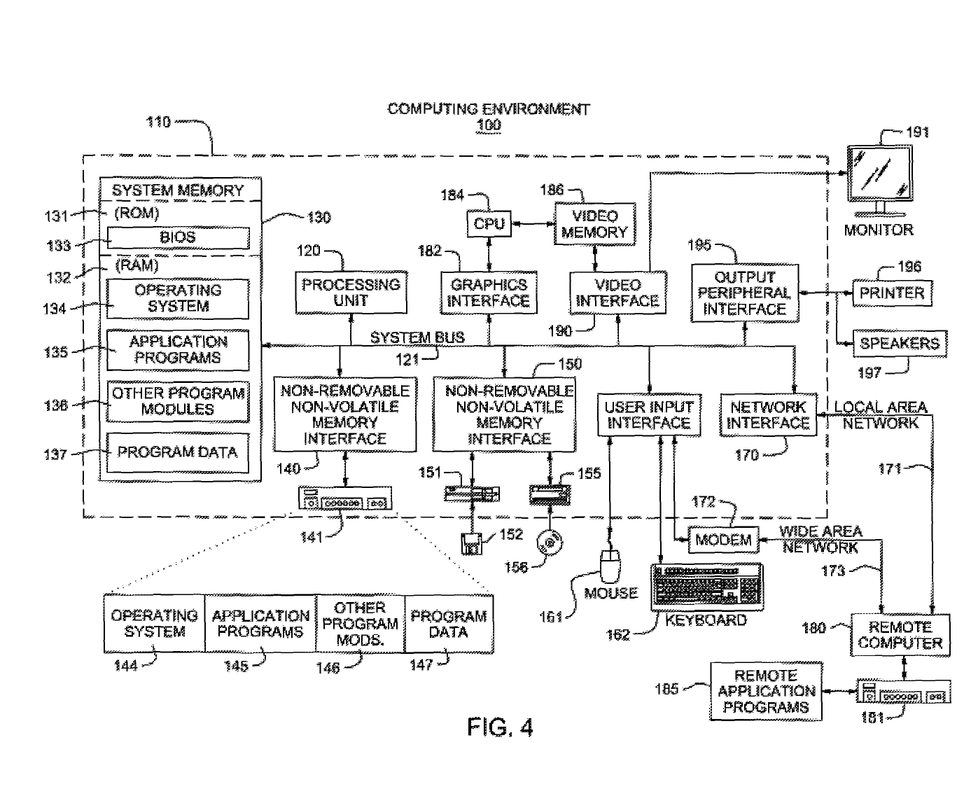

The method of the present invention will be generally implemented by a computer executing a sequence of program instructions for carrying out the steps of the method and may be embodied in a computer program product comprising media storing the program instructions. For example, FIG. 4 and the following discussion provide a brief general description of a suitable computing environment in which the invention may be implemented. It should be understood, however, that handheld, portable, and other computing devices of all kinds are contemplated for use in connection with the present invention. While a general-purpose computer is described below, this is but one example, the present invention may be implemented in an environment of networked hosted services in which very little or minimal client resources are implicated, e.g., a networked environment in which the client device serves merely as a browser or interface to the World Wide Web.

Although not required, the invention can be implemented via an application-programming interface (API), for use by a developer, and/or included within the network browsing software, which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 4, thus, illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 4, an exemplary system for implementing the invention includes a general purpose-computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 4 illustrates operating system 134, application, programs 135, other program modules 136, and program data 137.

The computer 110 may also include other removable/non-removable, volatile/nonvolatile computer storage media. By way of example only, FIG. 4 illustrates a hard disk drive 141 that reads form or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media, that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interlace 150.

The drives and their associated computer storage media discussed above and illustrated in FIG. 4 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host-processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of indexing a set of statements described in accordance with a specified ontology, comprising the steps of:
defining a set of indexing rules; and
using said indexing rules to examine said set of statements to identify selected ones of the set of statements and to generate one or more indices from said selected ones of the statements.

2. A method according to claim 1, wherein:
each of the set of statements includes a predicate;
the set of indexing rules identifies selected ones of said predicates; and
the using step includes the step of examining said set of statements to identify the statements in said set of statements that have predicates identified by said set of indexing rules.

3. A method according to claim 1, wherein the using step includes the steps of:
generating a plurality of indices from said selected ones of the statements; and
using said indexing rules to identify, for each of the selected ones of the statements, one of the plurality of indices, and inserting at least part of said each of the selected ones of the statements into the identified one of the indices.

4. A method according to claim 1, wherein the using step includes the step of examining the statements at defined times to identify said selected ones of the statements.

5. A method according to claim 4, wherein the set of statements are stored in a database, and the examining step includes the step of examining each of said sot of statements any time said each statement is changed in said database.

6. A method according to claim 4, wherein the set of statements are stored in a database, and the examining step includes the step of examining each of said set of statements any time said each statement is added to or removed from said database.

7. A method according to claim 1, wherein the using step includes the steps of:
generating an index object from each of the selected ones of the statements; and
inserting the index objects into said one or more indices.

8. A system for indexing a set of statements described in accordance with a specified ontology, comprising:
an ontology database storing a multitude of ontology statements; and
a processor including computer readable program code for using a defined set of indexing rules to examine said set of statements to identify selected ones of the set of statements and to generate one or more indices from said selected ones of the statements.

9. A system according to claim 8, wherein:
each of the set of statements includes a predicate;
the set of indexing rules identifies selected ones of said predicates; and
the computer readable program code includes a first portion for examining said set of statements to identify the statements in said set of statements that have predicates identified by said set of indexing rules.

10. A system according to claim 8, wherein the computer readable program code includes:
a first portion for generating a plurality of indices from said selected ones of the statements; and
a second portion for using said indexing rules to identify, for each of the selected ones of the statements, one of the plurality of indices, and inserting at least part of said each of the selected ones of the statements into the identified one of the indices.

11. A system according to claim 8, wherein the computer readable program code includes a first portion for examining the statements at defined times to identify said selected ones of the statements.

12. A system according to claim 11, wherein the set of statements are stored in a database, and the first portion of the computer readable program code examines each of said set of statements any time said each statement is changed in said database.

13. A system according to claim 11, wherein the set of statements are stored in a database, and the first portion of the computer readable program code examines each statement in the database any time said each statement is added to or removed from said database.

14. A system according to claim 8, wherein the computer readable program code includes:
a first portion for generating an index object from each of the selected ones of the statements; and
a second portion for inserting the index objects into said one or more indices.

15. A program storage device readable by machine, tangibly embodying a program of instructions executable by the machine to perform method steps for indexing a set of statements described in accordance with a specified ontology, said method steps comprising:
defining a set of indexing rules; and
using said indexing rules to examine said set of statements to identify selected ones of the set of statements and to generate one or more indices from said selected ones of the statements.

16. A program storage device according to claim 15, wherein:
each of the set of statements includes a predicate;
the set of indexing rules identifies selected ones of said predicates; and
the using step includes the step of examining said set of statements to identify the statements in said set of statements that have predicates identified by said set of indexing rules.

17. A program storage device according to claim 15, wherein the using step includes the steps of:
generating a plurality of indices from said selected ones of the statements; and
using said indexing rules to identify, for each of the selected ones of the statements, one of the plurality of indices, and inserting at least part of said each of the selected ones of the statements into the identified one of the indices.

18. A program storage device according to claim 15, wherein the using step includes the step of examining the statements at defined times to identify said selected ones of the statements.

19. A program storage device according to claim 18, wherein the set of statements are stored in a database, and the examining step includes the step of examining each of said set of statements any time said each statement is changed in said database.

20. A program storage device according to claim 18, wherein the set of statements are stored in a database, and the examining step includes the step of examining each of said set of statements any time said each statement is added to or removed from said database.
